(19) United States
(12) Patent Application Publication
(10) Pub. No.: US 2006/0083271 A1
(43) Pub. Date: Apr. 20, 2006

(54) Apparatus for transmitting frame and method for controlling transmission of frame for strict synchronization

(75) Inventors: Se-Youn Lim, Seoul (KR); Jae-Yeon Song, Seoul (KR); Seo-Won Kwon, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/243,737

(22) Filed: Oct. 5, 2005

(30) Foreign Application Priority Data
Oct. 19, 2004 (KR) 2004-83574

(51) Int. Cl. H04J 3/04

(52) U.S. Cl. 370/535

(57) ABSTRACT

Disclosed are an apparatus for transmitting a frame and a method for controlling the transmission of a frame for strict synchronization. The frame transmission apparatus includes a cycle controller for providing information about a transmission block of the transmission cycle, a transmission multiplexer for multiplexing and outputting synchronous frames and asynchronous frames input thereto through the frame transmission apparatus in one transmission cycle, and a transmission controller for controlling the transmission multiplexer such that total sizes of the multiplexed synchronous frames and asynchronous frames do not exceed a size of one transmission cycle using information about the sizes of the synchronous frames, the sizes of the asynchronous frames, and the transmission block of the transmission cycle provided by the cycle controller.

### CLAIM OF PRIORITY

This application claims priority to an application entitled “Apparatus for Transmitting Frame and Method For Controlling Transmission of Frame For Strict Synchronization,” filed in the Korean Intellectual Property Office on Oct. 19, 2004 and assigned Serial No. 2004-83574, the contents of which are incorporated herein by reference.

### BACKGROUND OF THE INVENTION

1. Field of the Invention

The present invention relates to a synchronous Ethernet capable of efficiently providing a real-time service and a non-real time service simultaneously through an Ethernet.

2. Description of the Related Art

Recently, Ethernet has been standardized by Institute of Electrical and Electronics Engineers (IEEE) 802.3. Since the conventional Ethernets provides an access using a carrier sense multiple access/collision detect (CSMA/CD) protocol defined in IEEE 802.3, an upper class service frame is initially transmitted as an Ethernet frame while maintaining the Inter Frame Gap (IFG), and the frames may be transmitted according to a frame generation sequence regardless of the type of the upper service frames.

Ethernet is not suitable for transmitting a moving picture or a voice data due to a transmission time delay. However, a technique of transmitting synchronous data such as video data/voice data using the conventional Ethernet has been actively discussed. Ethernet for transmitting synchronous data under the discussion is called a synchronous Ethernet.

In a synchronous Ethernet, a frame is transmitted based on a cycle. Generally, one cycle has 125 μs. One cycle is divided into synchronization duration in which synchronous frames can be transmitted, and asynchronization duration in which asynchronous frames can be transmitted. The synchronous frames correspond to fixed-length Ethernet frames, and the asynchronous frames correspond to variable-length Ethernet frames.

FIG. 1 is a view illustrating an example of a structure of a transmission cycle in a typical synchronous Ethernet.

As shown, the synchronous Ethernet transmits data with a transmission cycle 10 of 125 μsec, in which each transmission cycle includes a Sync field 100 for transmitting synchronous data and Async field 110 for transmitting asynchronous data.

In more detail, the Sync frame module 100 for transmission of synchronous data has the highest priority in the transmission cycle and includes 738-byte sub frames 101, 102, and 103 according to a proposal under the current discussion. In addition, the Async frame module 110 for transmission of the asynchronous data includes sub-asynchronous frames 111, 112, and 113 having a variable length in a corresponding area.

As shown in FIG. 1, the synchronous Ethernet must maintain an exact cycle because the transmission is based on a cycle scheme. However, it is difficult for the asynchronous frame to maintain an exact frame because the asynchronous frame has a variable length.

FIG. 2 is a view for explaining a case in which a synchronization mismatch may occur due to asynchronous frames in the synchronous Ethernet.

As shown in FIG. 2, cycles 21, 22, and 23 include synchronous frames 201, 202, 203, 207, 208, 209, 212, and 213 and asynchronous frames 204, 205, 206, 210, and 211. The synchronous Ethernet transmits the synchronous data by synchronizing the data with starting points of the cycles 21, 22, and 23. However, in FIG. 2, the synchronization of the cycle 22 is damaged due to the asynchronous frame 206 of the N^{th} cycle 21. Accordingly, the starting point of the (N+1)^{th} cycle 22 is delayed by Δt₁ 214, and the starting point of the (N+2)^{th} cycle 23 is delayed by Δt₂ 215. As described above, the transmission of variable-length asynchronous frames cause a delay in cycles, and the delay has an adverse effect on the transmission of synchronous frames, so that it is difficult to efficiently provide a real-time service.

### SUMMARY OF THE INVENTION

Accordingly, the present invention has been made to solve the above-mentioned problems occurring in the prior art and provides additional advantages, by providing a method for controlling the transmission of a frame for a strict synchronization, which may control an output of an asynchronous frame being transmitted in order to provide the strict synchronization between transmission cycles in a synchronous Ethernet apparatus.

In one embodiment, there is provided a frame transmission apparatus for attaining a strict frame synchronization with respect to a transmission cycle of a synchronous Ethernet system. The frame transmission apparatus includes a cycle controller for providing information about a transmission block of the transmission cycle, a transmission multiplexer for multiplexing and outputting synchronous frames and asynchronous frames input thereto so as to be transmitted through the frame transmission apparatus in one transmission cycle, and a transmission controller for controlling the transmission multiplexer such that total sizes of the multiplexed synchronous frames and asynchronous frames do not exceed a size of one transmission cycle using information about the sizes of the synchronous frames, the asynchronous frames, and the transmission block of the transmission cycle provided by the cycle controller.

In another embodiment, there is provided a frame transmission method for attaining strict frame synchronization with respect to a transmission cycle in a synchronous Ethernet system. The frame transmission method includes the steps of, (1) controlling input synchronous frames to be transmitted until an end part of a synchronous frame transmission block reaches in one transmission cycle if the transmission cycle starts, (2) determining if an end part of an asynchronous frame transmission block reaches in the transmission cycle after the end part of the synchronous frame transmission block reaches, and (3) controlling an output of an input asynchronous frame by comparing a size of the input asynchronous frame with a size of the asynchronous frame transmission block in the transmission cycle if the end part of the asynchronous frame transmission block does not reach in the transmission cycle.

### BRIEF DESCRIPTION OF THE DRAWINGS

The above features and advantages of the present invention will be more apparent from the following detailed description taken in conjunction with the accompanying drawings, in which:

FIG. 1 illustrates an example of a structure of a transmission cycle in a typical synchronous Ethernet;

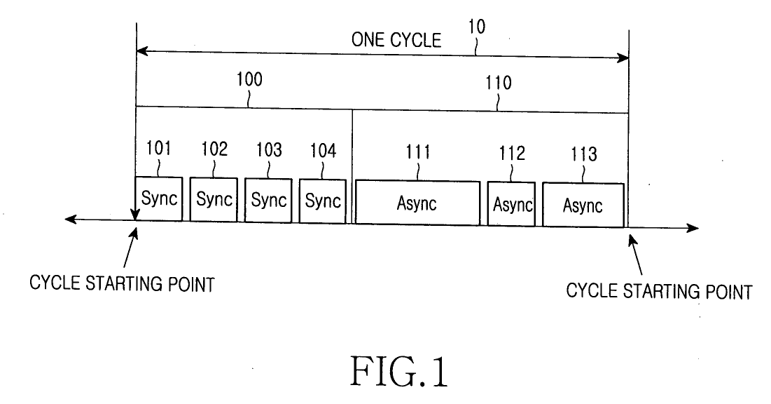

FIG. 2 is a view for explaining a case in which synchronization mismatch occurs due to asynchronous frames in a synchronous Ethernet;

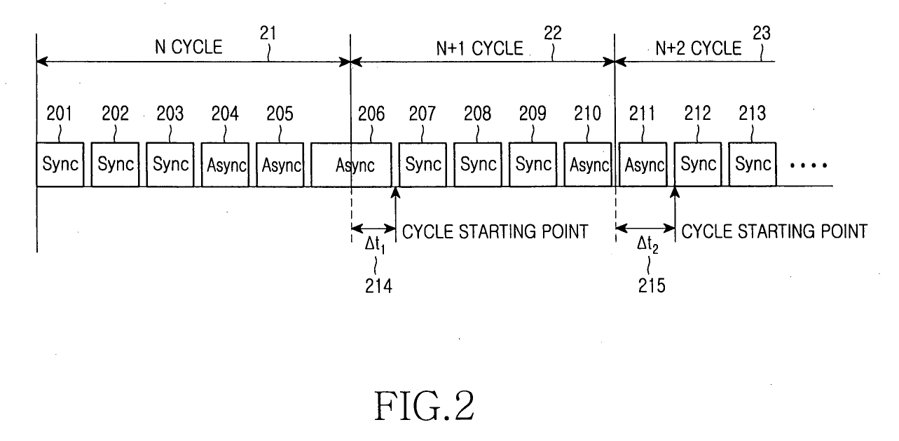

FIG. 3 illustrates transmission cycles in which frame transmission is controlled in a strict synchronization of frames according to the present invention;

FIG. 4 is a block diagram illustrating a structure of a device for controlling frame transmission for a strict synchronization according to the present invention; and

FIG. 5 is a flowchart illustrating a method for controlling frame transmission for a strict synchronization according to the present invention.

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

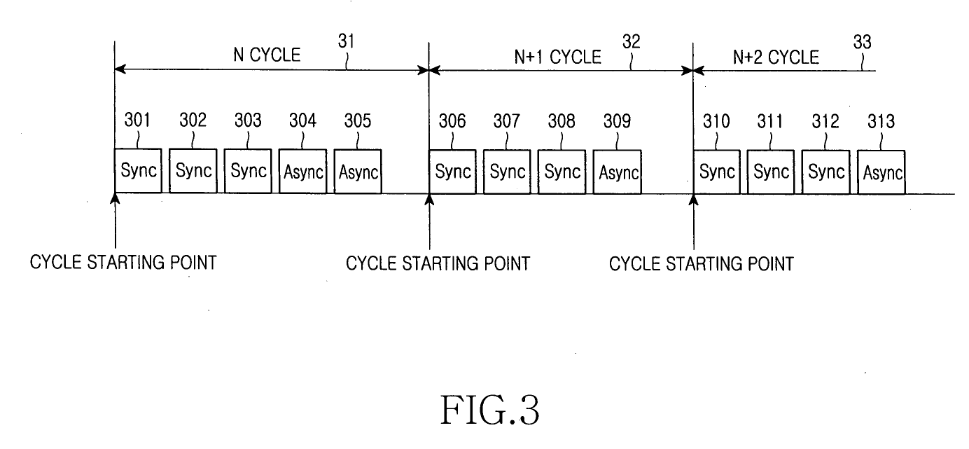

FIG. 3 illustrates the transmission cycles in which a frame transmission is controlled to enable a strict synchronization in accordance with the teachings of the present invention.

As shown in FIG. 3, cycles 31, 32, and 33 according to the present invention include synchronous frames 301, 302, 303, 306, 307, 308, 310, 311, and 312 and asynchronous frames 304, 305, 309, and 313.I It can be understood from FIG. 3 that an accurate frame synchronization is achieved at a starting point of each cycle. In the case of the N^{th} cycle 31, a spare transmission block remains in the N^{th} cycle 31 after the transmission of the asynchronous frame 305, and it has a size smaller than the size of the first asynchronous frame 309 in the (N+1)^{th} cycle. As a result, the spare transmission block is in an empty state, then the asynchronous frame 309 having a next sequence is transmitted at a next cycle. Accordingly, I it is possible to maintain a strict synchronization.

As described above, according to the present invention, the size of an asynchronous frame A to be transmitted is compared with the size of an asynchronous frame transmission block B remaining in a corresponding transmission cycle. If the asynchronous frame A to be transmitted is larger than the asynchronous frame transmission block, the corresponding transmission cycle transmits frames while maintaining the asynchronous frame transmission block B in an empty state, and the asynchronous frame A, which is not transmitted in the corresponding transmission cycle, is transmitted in a next cycle.

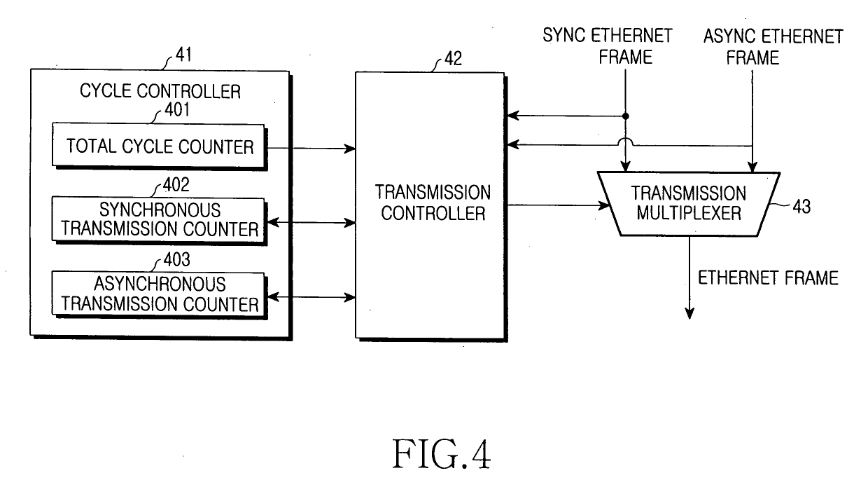

To this end, it is necessary for a MAC layer or the upper layer of the MAC layer to compare and control the synchronous frames, asynchronous frames, and a transmission cycle block used for frame transmission. A device for controlling frame transmission is shown in FIG. 4.

FIG. 4 is a block diagram illustrating the structure of a device for controlling a frame transmission for realizing a strict synchronization according to the present invention.

As shown in FIG. 4, the device for controlling the frame transmission for strict synchronization includes a cycle controller 41 for providing information about a block in a transmission cycle, a transmission multiplexer 43 for multiplexing and outputting a synchronous frame and an asynchronous frame input for transmission, and a transmission controller 42 for controlling the output of the transmission multiplexer 43 using information about sizes of both a synchronous frame and an asynchronous frame input for transmission and about a block in a transmission cycle provided by the cycle controller 41.

In particular, the cycle controller 41 includes a total cycle counter 401 for providing information about a total transmission block of a transmission cycle, a synchronous transmission counter 402 for providing information about a synchronization frame block according to the synchronization frame output information from the transmission controller 42, and an asynchronous transmission counter 403 for providing information about an asynchronization frame block according to the asynchronization frame output information from the transmission controller 42.

Hereinafter, the operation of the device for controlling the frame transmission for strict synchronization utilizing the above described structure will be described.

The total cycle counter 401 of the cycle controller 41 manages a starting point and an ending point of a corresponding transmission cycle having 8 kHZ. In other words, the total cycle counter 401 informs the transmission controller 42 of a starting point of each transmission cycle having 125 μs.

The transmission multiplexer 43 multiplexes and outputs input synchronous frames and asynchronous frames in one cycle.

In the case of the synchronous frames, the synchronous frames have predetermined sizes, and the number of the synchronous frames to be transmitted is determined, so that they are multiplexed according to the input sequence thereof under the control of the transmission controller 42. A signal sync_cycle_en used for reporting information about synchronous frame transmission duration and enables the transmission of only synchronous frames. The synchronous frames to be transmitted have fixed lengths, and the synchronous frame transmission duration in one transmission cycle is proportion to the number S of the synchronous frames. As such, the synchronous frame transmission duration may be represented as “S*N”. Accordingly, the synchronous frames are not transmitted in excess of the synchronous frame transmission duration.

In addition, in the case of the synchronous frames, since the transmission controller 42 previously has multiplexing information including the number of synchronous frames to be transmitted and a corresponding transmission block is set to transmit the predetermined number of synchronous frames, information about the corresponding transmission block can be known even though the information relating to a synchronous frame transmission block is not transmitted/received. Thus, a description relating to the transmission/reception of information about a synchronous frame transmission block by the synchronous transmission counter 402 of the cycle controller 41 can be omitted in the present invention. That is, in case of asynchronous frames, since sizes of asynchronous frames are different, information relating to the transmission block can be known if the number of the synchronous frame is know. Accordingly, the transmission/reception of the information about the transmission block is not necessary.

In the case of asynchronous frames, the transmission controller 42 receives information about the sizes of input asynchronous frames, compares sizes of a currently remaining asynchronous transmission block delivered by the asynchronous transmission counter 403 with the sizes of the input asynchronous frames, and delivers a control signal relating to an output state of a corresponding asynchronous frame to the transmission multiplexer 43. If the corresponding asynchronous frames are output, the transmission controller 42 sends information about the size of the output asynchronous frame to the asynchronous transmission counter 403 and controls the asynchronous transmission counter 403 to update information thereof.

Herein, asynchronous frames are distinguished from each other through a signal async_cycle_en for informing asynchronous frame transmission duration.

Accordingly, when asynchronous frames are transmitted, it is necessary to control the transmission of the asynchronous frames by comparing the length of an asynchronous frame to be transmitted with the size of a remaining asynchronous transmission block. Herein, “Tasync” is defined as an asynchronous frame transmission block assigned in one transmission cycle, “Tsent” is defined as the summation of sizes of asynchronous frames having been transmitted in one cycle, and “Lasync” is defined as the length of an asynchronous frame to be transmitted. Hereinafter, the operation of the transmission controller using the definition will be described.

If “Tasync-Tsent” is larger than the “Lasync”, the transmission multiplexer 43 is controlled so that a corresponding asynchronous frame can be output. If “Tasync-Tsent” is smaller than the “Lasync”, the transmission multiplexer 43 is controlled such that the output of the corresponding asynchronous frame can be prevented.

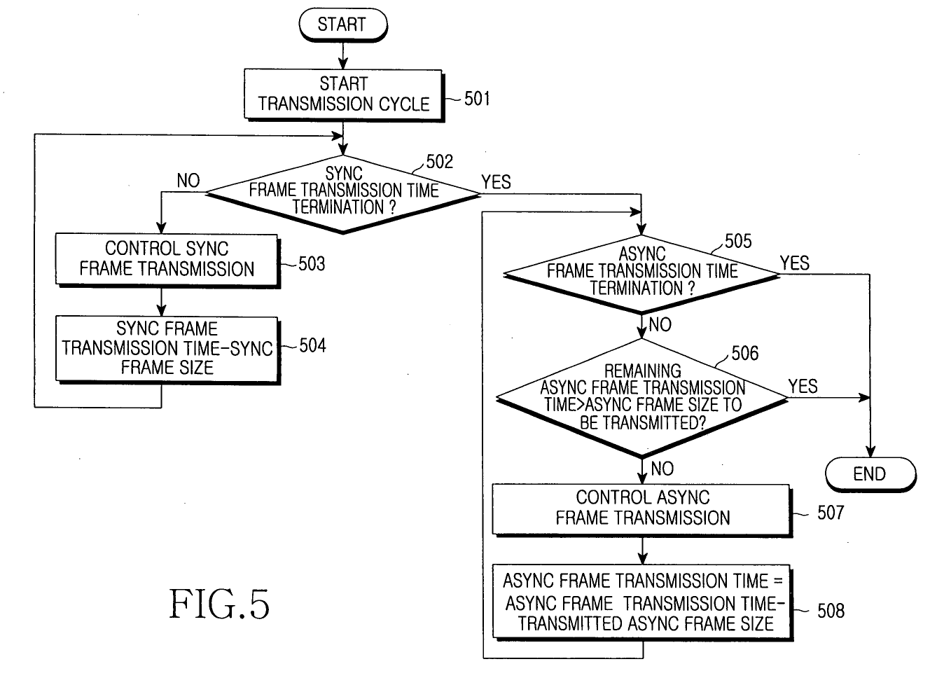

FIG. 5 is a flowchart illustrating a method for controlling the frame transmission for a strict synchronization according to the present invention.

Note that although the term, “frame transmission block” is used together with the term, “frame transmission time”, the terms, “block” and “time” indicate the same meaning as the frame transmission block in a transmission cycle is divided in view of time.

If a transmission cycle starts based on the information of the total cycle counter 401 (step 501), synchronous frames are transmitted until the end of the synchronous frame transmission block is reached (step 502, 503, and 504). In more detail, step 503 represents the step of controlling the synchronous frame transmission such that one synchronous frame is output until a remaining synchronous frame transmission block does not exist, and step 504 represents the step of subtracting the size of the synchronous frame from the size of the synchronization frame transmission block that are repeated. That is, the size of an initially transmitted synchronous frame is subtracted from a transmission block of total synchronous frames, and the size of a synchronous frame to be transmitted is subtracted from the transmission block of remaining synchronous frame. This subtraction step is repeated for synchronous frames to be transmitted in sequence, and this repetition step is preceded until any synchronous frame cannot be transmitted through the transmission block of remaining synchronous frames.

If synchronous frame transmission is completed (step 502), it is determined if there is a remaining asynchronous frame transmission block (step 505). If it is determined that there is the remaining asynchronous frame transmission block, it is determined if the size of the remaining asynchronous frame transmission block is larger than the size of an asynchronous frame to be transmitted (step 506).

If there is no remaining asynchronous frame transmission block (step 505) or if the size of the remaining asynchronous frame transmission block is smaller than the size of the asynchronous frame to be transmitted (step 506), the transmission of an asynchronous frame is terminated.

If the size of the remaining asynchronous frame transmission block is larger than the size of the asynchronous frame to be transmitted (step 506), the asynchronous frame transmission is controlled such that the asynchronous frame is output in a corresponding cycle (step 507) and information about the remaining asynchronous frame transmission block is updated (step 508).

Having thus described an embodiment of a method for ensuring a strict synchronization of frames in a synchronous Ethernet system, it should be apparent to those skilled in the art that certain advantages of the system have been achieved. Further, it should be noted that the method according to the present invention can be realized by a program and can be stored in a recording medium (such as a CD ROM, a RAM, a floppy disk, a hard disk, an optical and magnetic disk, etc.) in a format that can be read by a computer.

While the invention has been shown and described with reference to certain preferred embodiments thereof, it will be understood by those skilled in the art that various changes in form and details may be made therein without departing from the spirit and scope of the invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A frame transmission apparatus for attaining a strict frame synchronization with respect to a transmission cycle of a synchronous Ethernet system, the frame transmission apparatus comprising:
a cycle controller for providing information relating to a transmission block of the transmission cycle;
a transmission multiplexer for multiplexing and outputting synchronous frames and asynchronous frames input thereto for transmission in one transmission cycle; and
a transmission controller for controlling the transmission multiplexer such that total sizes of the multiplexed synchronous frames and asynchronous frames do not exceed a size of one transmission cycle using information about sizes of the synchronous frames, sizes of the asynchronous frames, and the transmission block of the transmission cycle provided by the cycle controller.

2. The frame transmission apparatus as claimed in claim 2, wherein the cycle controller comprises:
a total cycle counter for providing information relating to total transmission block in the one transmission cycle; and
an asynchronous transmission counter for receiving output information about the asynchronization frames from the transmission controller and updating information relating to the asynchronous frame block in the one cycle.

3. The frame transmission apparatus as claimed in claim 2, further comprising a synchronous transmission counter for receiving an output information relating to the synchronization frames from the transmission controller, and updating information about the synchronous frame block in the one cycle.

4. The frame transmission apparatus as claimed in claim 1, wherein the transmission controller controls the transmission multiplexer to compare a length (Lasync) of an asynchronous frame, which is input into the transmission multiplexer, with remaining asynchronous transmission block (Tasync-Tsent), output the asynchronous frame if “Tasync-Tsent” is larger than the “Lasync”, and prevent output of the asynchronous frame if “Tasync-Tsent” is smaller than the “Lasync”, the “Tasync” being an asynchronous frame transmission block assigned in one transmission cycle, “Tsent” being summation of sizes of asynchronous frames having been transmitted in one transmission cycle.

5. The frame transmission apparatus as claimed in claim 2, wherein the total cycle counter manages a starting point and an ending point of the one transmission cycle.

6. The frame transmission apparatus as claimed in claim 1, wherein the one transmission cycle is 8 kHZ.

7. The frame transmission apparatus as claimed in claim 2, wherein the transmission controller controls the transmission multiplexer to compare a length (Lasync) of an asynchronous frame, which is input into the transmission multiplexer, with remaining asynchronous transmission block (Tasync-Tsent), output the asynchronous frame if “Tasync-Tsent” is larger than the “Lasync”, and prevent output of the asynchronous frame if “Tasync-Tsent” is smaller than the “Lasync”, the “Tasync” being an asynchronous frame transmission block assigned in one transmission cycle, “Tsent” being summation of sizes of asynchronous frames having been transmitted in one transmission cycle.

8. The frame transmission apparatus as claimed in claim 3, wherein the transmission controller controls the transmission multiplexer to compare a length (Lasync) of an asynchronous frame, which is input into the transmission multiplexer, with remaining asynchronous transmission block (Tasync-Tsent), output the asynchronous frame if “Tasync-Tsent” is larger than the “Lasync”, and prevent output of the asynchronous frame if “Tasync-Tsent” is smaller than the “Lasync”, the “Tasync” being an asynchronous frame transmission block assigned in one transmission cycle, “Tsent” being summation of sizes of asynchronous frames having been transmitted in one transmission cycle.

9. A frame transmission method for attaining a strict frame synchronization with respect to a transmission cycle in a synchronous Ethernet system, the method comprising the steps of:
(1) controlling input synchronous frames to be transmitted until an end part of a synchronous frame transmission block reaches in one transmission cycle if the transmission cycle starts;
(2) determining if an end part of an asynchronous frame transmission block reaches in the transmission cycle after the end part of the synchronous frame transmission block reaches; and
(3) controlling output of an input asynchronous frame by comparing a size of the input asynchronous frame with a size of the asynchronous frame transmission block in the transmission cycle if the end part of the asynchronous frame transmission block does not reach in the transmission cycle.

10. The frame transmission method as claimed in claim 9, wherein step (3) comprises the steps of:
(4) controlling transmission of the asynchronous frame in such a manner that the size of the input asynchronous frame is compared with a size of the asynchronous frame transmission block of the transmission cycle if the end part of the asynchronous frame transmission block does not reach in the transmission cycle, and the input asynchronous frame is outputted if the size of the asynchronous frame transmission block is larger than the size of the asynchronous frame to be transmitted;
(5) controlling transmission of the asynchronous frame in such a manner that the size of the input asynchronous frame is compared with the size of the asynchronous frame transmission block of the transmission cycle if the end part of the asynchronous frame transmission block does not reach in the transmission cycle, and output of the input asynchronous frame is prevented if the size of the asynchronous frame transmission block is smaller than the size of the asynchronous frame; and
(6) updating information about the asynchronous frame transmission block as the asynchronous frame is output in step (4).
